(19) United States
(12) Patent Application Publication
(10) Pub. No.: US 2009/0089515 A1
(43) Pub. Date: Apr. 2, 2009

(54) Memory Controller for Performing Memory Block Initialization and Copy

(75) Inventors: Gerald Paul Michalak, Cary, NC (US); Richard Gerard Hofmann, Cary, NC (US); Perry Willmann Remaklus, JR., Raleigh, NC (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 11/865,970

(22) Filed: Oct. 2, 2007

(51) Int. Cl. G06F 12/00

(52) U.S. Cl. 711/154

(57) ABSTRACT

A memory controller and methods for performing memory block initialization and copy functions with reduced bus traffic are disclosed. The memory controller can perform the memory initialization by receiving a start address of a memory, an end address of the memory and a fill value. The fill value is then written from the memory controller to the memory in a fill range of arbitrary length defined by the start address and end address.

### FIELD OF DISCLOSURE

Embodiments of the invention relate to a memory controller and to computer systems including the memory controller. More particularly, embodiments of the invention relate to a memory controller configured to perform memory block initialization and copy functions and to methods for performing memory block initialization and copy functions with reduced bus traffic.

### BACKGROUND

A conventional computer system typically includes one or more memory modules for storing software applications and program data, and a memory controller that controls access to the memory module under the direction of a microprocessor. Conventional memory modules are typically powered up and initialized based on a predefined sequence of commands in order to operate properly (e.g., during a “boot” operation). Failure to follow the required procedures for power up and initialization may result in undefined operation.

Aside from boot or power-up initialization operations, memory initialization may be performed during normal system operation to reserve or allocate memory to one or more software programs or applications (e.g., a real-time streaming video application) being executed or scheduled to be executed by the computer system. These types of memory initializations are typically micro-managed by the processor. For example, an initialization program may be executed by the processor via a loop, with each iteration of the loop generating initialization commands which are sent to the memory controller instructing the memory controller to initialize one or more designated memory addresses. The initialization commands sent by the processor to the memory controller include memory writes instructing the memory controller to set the designated memory blocks to a given initialization value or logic level (e.g., a higher logic level or logic “1”, a lower logic level or logic “0”, etc.).

For example, referring to FIG. 1A, the conventional memory initialization loop executed by the processor 12 in a conventional computer system 10 may be executed with programming logic as follows:

```
For (Address = [0000] until [Address] = 10000) {
    Data [Address] = Initialization_Value;
    Address = Address + 1;
}
```

Accordingly, as shown in the programming logic above, in order to initialize data at 10,000 memory addresses, the processor 12 executes a for-loop with 10,000 iterations, with each iteration generating an instruction (e.g., a write command), which is sent to the memory controller 16 via bus 14, for initializing data at one particular memory location or address in memory device(s) 18. Each generated instruction or write command includes one memory address and one initialization value. Accordingly, in the above-example, the processor 12 sends 10,000 memory addresses and 10,000 initialization values to the memory controller 16, which executes the initialization instructions. Further, while the programming logic provided above increments the parameter Address by 1 for each iteration of the for-loop, other conventional implementations may increment the parameter Address by a value other than 1 (e.g., a power of 2).

As shown above with respect to the example of conventional initialization programming logic, customized initializations of memory blocks for software applications may include a number of processor-executed write commands, which may consume valuable system resources (e.g., bus bandwidth, processor power, etc.). Further, the processor 12 must wait until after the initialization operation before issuing memory commands (e.g., read commands, write commands, etc.) for the target memory addresses, which may further delay the computer system 10. For example, the processor 12 may monitor the initialization operation in order to wait until the initialization operation is complete before issuing memory commands for the initialized memory addresses in memory 18.

### SUMMARY

Embodiments of the invention relate to a memory controller configured to perform memory block initialization and copy functions and to methods for performing memory block initialization and copy functions with reduced bus traffic.

Accordingly, an embodiment of the invention can include a memory controller comprising: logic configured to receive a start address of a memory; logic configured to receive an end address of the memory or a length; logic configured to receive a fill value; and logic configured to write the fill value to the memory in a fill range of arbitrary length defined by the start address and end address or length.

Another embodiment of the invention can include a method for initializing or copying data in a memory, performed at a memory controller, the method comprising: receiving a start address of a memory; receiving an end address of the memory or a length; receiving a fill value; and writing the fill value to the memory in a fill range of arbitrary length defined by the start address and end address or length.

Another embodiment of the invention can include a computer system, comprising: a processor configured to send one of a memory initialization instruction or a memory copy instruction including an arbitrary range of memory addresses to initialize or copy; and a memory controller coupled to the processor, wherein the memory controller is configured to receive the memory initialization instruction or memory copy instruction from the processor, and is configured to initialize or copy the range of memory addresses in accordance with the received instruction.

Another embodiment of the invention can include a method for memory initialization performed at a memory controller comprising; receiving a memory initialization command including a start address, an end address and an initialization value; setting a current address to the start address; writing the initialization value to the memory at the current address; incrementing the current address; and repeating the writing and incrementing, if the current address is not greater than the end address.

Another embodiment of the invention can include a method for copying memory performed at a memory controller comprising; receiving a memory copy command including a source address, a destination address and a copy count; copying data from the source address to the destination address; incrementing the source address and the destination address; incrementing a current count; and repeating the copying and incrementing, if the current count is not greater than the copy count.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain principles of the invention.

FIG. 1A is a block diagram illustrating a computing system using a conventional initialization process.

FIG. 1B is a block diagram illustrating a computing system using an initialization process having reduced bus traffic and processor utilization.

FIGS. 2A-D are illustrations of a two-channel bus and associated instructions communicated thereon.

FIG. 3 is a flowchart illustrating a memory initialization/copy process performed at a processor of a computing system.

FIG. 4A is a flowchart illustrating a memory initialization/copy process performed at a memory controller of a computing system.

FIG. 4B is a flowchart illustrating an optional process performed during the memory initialization process.

FIG. 5 is an illustration an alternate memory initialization/copy process performed at a processor of a computing system.

FIG. 6A is a flowchart illustrating a memory copy process performed at a memory controller.

FIG. 6B is a flowchart illustrating a memory initialization performed at a memory controller.

FIG. 7 is a block diagram illustrating a memory controller including initialization logic and related elements.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of embodiments of the invention. Also, as used herein, the term “and/or” includes any and all combinations of one or more of the associated listed items.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

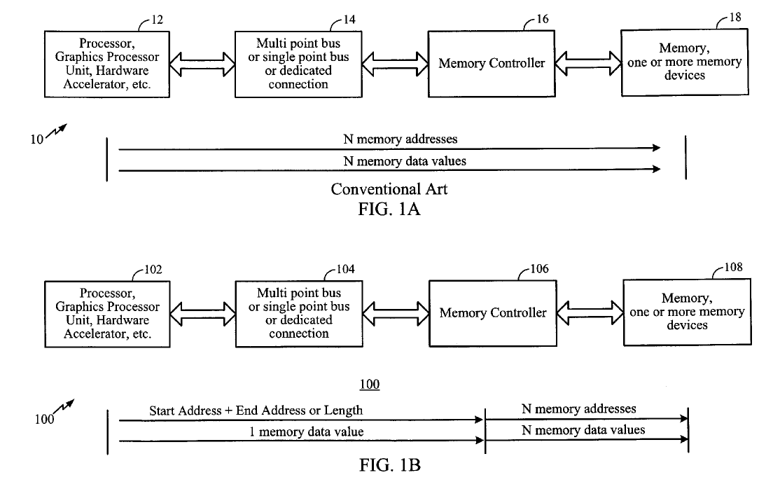

In order to better understand embodiments of the invention, an example computing system will be described, followed by an example of a memory initialization process performed within the example computing process. FIG. 1B is a block diagram illustrating a computing system 100 according to embodiments of the invention.

In the embodiment of FIG. 1B, a processor 102 is coupled to a memory controller 106 via bus 104. The memory controller 106 is coupled to a memory 108. In an example, the processor 102 may correspond to any well-known processor. For example, the processor 102 may be embodied as a graphics processor unit (GPU), a central processing unit (CPU), a digital signal processor (DSP), a hardware accelerator, and the like. Further, processor 102 may represent multiple processors or masters and other related elements (e.g., interconnect/bus arbiter) that can control the bus 104 and/or memory controller 106. The bus connections 104 between the processor 102 and memory controller 106, and likewise the memory controller 106 and the memory 108, may be either a direct connection or an indirect connection. For example, the processor 102 and memory controller 106 may be connected via bus 104, which may be a multi point bus, a single point bus, a two-channel bus and/or a dedicated connection. In the embodiment of FIG. 1B, the computing system 100 may represent any type of computing system, such as a server, personal computer, laptop, a battery-powered, pocket-sized hand-held PC, a personal digital assistant (PDA) or other mobile computing device (e.g., a mobile phone).

Further, memory 108 may be representative of any well-known type of memory. For example, memory 108 may include one or more of a Single Inline Memory Module (SIMM), a Dual Inline Memory Module (DIMM), flash memory (e.g., NAND flash memory, NOR flash memory, etc.), random access memory (RAM) such as synchronous RAM (SRAM), magnetic RAM (MRAM), dynamic RAM (DRAM), and electrically erasable programmable read-only memory (EEPROM).

At the heart of complicated modern digital system designs is an interconnect that routes transfer requests on a bus (e.g., 104/204). It will be appreciated that the interconnect is logic that routes transaction requests and write data from masters to slaves and read data and write responses from slaves to masters (e.g., to/from the (master) sending device 202 to (slave) receiving device 206). For example, the interconnect (which can be part of 102/202) can be used in a system with multiple masters (e.g., multiple processors) and/or multiple memory controllers. For example, the bus 104 moves information amongst the various processing functions resident in the system 100. The bus structure can include independent and separate address, read, and write buses. These connections allow for communication of transfer addresses from the sending device to the receiving device, the communication of read data from the receiving device to the sending device, and the communication of write data from sending to receiving device.

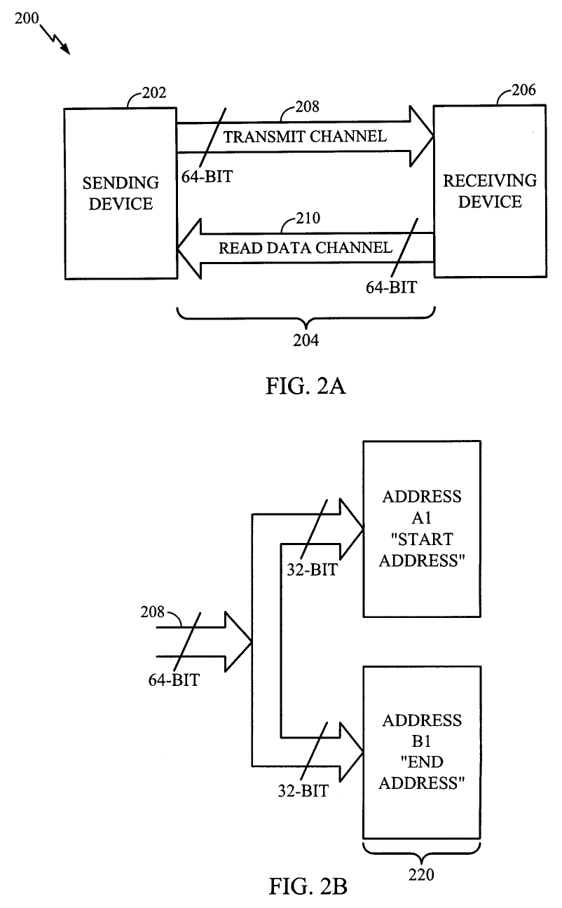

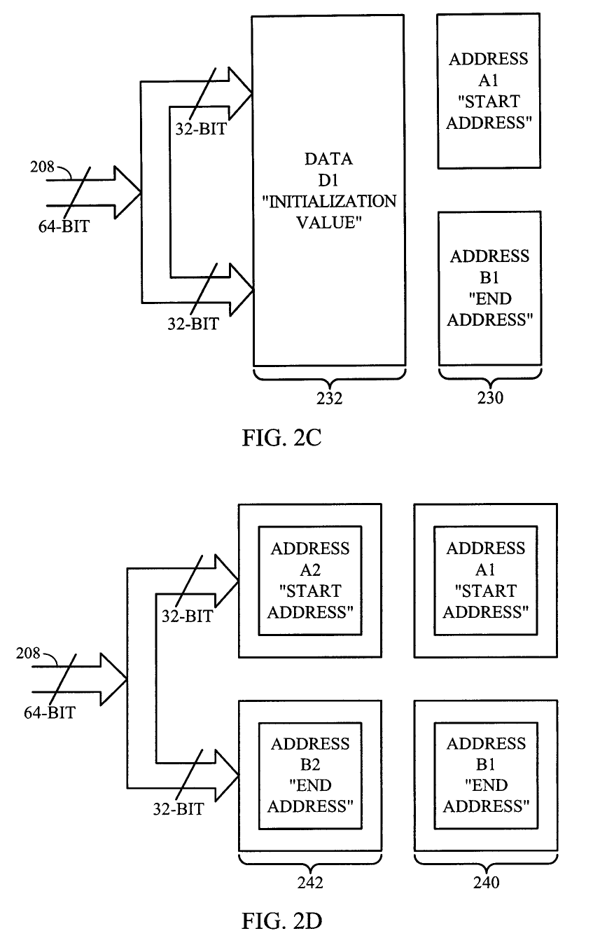

As illustrated in FIG. 2A, a bus 204 can reside between the sending 202 and receiving device 206. In the general system 200 illustrated, there is a need to be able to move data between devices (e.g., 202, 206). Embodiments of the invention describe a compact bus command for performing memory block initialization for system-on-a-chip designs and other system architectures. As used herein and illustrated, the transmit channel 208 is a generic medium for transmitting “information” between the sending 202 and the receiving 206 device. For example, in a time division multiplexed fashion different types of information may be broadcast from the sending device 202 to the receiving device 206. Some embodiments of the invention can use the illustrated two-channel bus 204 to facilitate memory initialization and copy commands. Additional details of the two-channel bus configuration can be obtained from U.S. patent application Ser. No. 10/833,716, entitled “A Multiple Address Two Channel Bus Structure”, filed on 04/27/2004, assigned to the present assignee and which is incorporated herein by reference in its entirety.

For example, using the illustrated two-channel bus structure 204, the sending device 202 may initiate a read or write transfer, or any combination thereof, by broadcasting the address, or addresses, on the transmit channel 208 during an address tenure. In the case of a read transfer request this is the only information that needs to be broadcast on the transmit channel 208. The receiving device 206 acknowledges this broadcast and subsequently provides the requested data by broadcasting the read data on the read data channel 210. In the case of a write transfer request the master (e.g., sending device 202) can subsequently follow the broadcast of the address on the transmit channel by broadcasting the write data to the receiving device 206 in a write tenure via the transmit channel 208. In the case of a memory initialization command both the “start” address and “end” (e.g., either an end address or length) for the memory initialization are broadcast simultaneously to the receiving device 206 (e.g., memory controller) during an address tenure. Further, an initialization value may be subsequently transmitted in a data tenure as an optional part of the memory initialization bus command according to embodiments of the invention.

The transmit channel may include control/signaling bits for indicating the type of data being broadcast (e.g., write address, read address, data) as part of the bits transmitted on transmit channel 208. Alternatively, a secondary signaling/control connection/bus (not shown) may be provided so the entire width (e.g., 64 bits) of the transmitting channel is available to send address/data information. Likewise, a secondary signaling/control connection/bus (not shown) may be provided from the receiving device to the sending device for control/signaling information. Details regarding secondary connections in the two-channel bus structure 204 can be found in the aforementioned U.S. patent application Ser. No. 10/833,716, so additional details will not be discussed further herein.

The sending device 202 may have control of the transmit channel 208 and may broadcast one or more transfer addresses prior to, during, or after an active write data tenure. Also the transmit channel 208 and the read data channel 210 may be independent. Accordingly, the broadcasting of address and write data by the sending device 202 may coincide with the broadcasting of read data by the receiving device 206 back to the sending device 202, which produces a very compact and efficient bus structure 204.

Another aspect of the-two-channel bus 204 is the capability to facilitate the pipelining of multiple data transfer requests in a single broadcast cycle from the sending device 202 to the receiving device 206. The broadcasting of multiple addresses at once increases performance of the bus 204. For example, by presenting a single bus request with the “start” and “end” addresses for a desired memory initialization operation in a single broadcast cycle, the command can be presented in a very efficient fashion.

In one embodiment of the invention, the transmit channel 208 and the read data channel 210 are 64-bits wide each. The transfer addresses presented to the receiving device 206 are 32-bits wide. This allows the sending device 202 to provide two transfer addresses, e.g., address A and address B, on the transmit channel 208 during a single broadcast cycle. In this case a broadcast cycle can be defined as one clock cycle.

For example, as illustrated in FIG. 2B, the sending device 202 can broadcast the data initialization start memory address on address A1 and the end memory address on address B1 during an address tenure 220. The interconnect and memory controller (receiving device 206) can process this request type based on this implicit positioning (e.g., the first 32 bits as address A1 and second 32 bits as address B1). The sending device 202 can indicate that this is a memory initialization transaction request via a unique transfer request attribute (e.g., MI[1]). The memory initialization request attribute (e.g., MI[1]) can cause the interconnect to forward this memory initialization transaction to the memory controller which controls the start address. In this configuration, the memory can be initialized to a predetermined value.

In another embodiment as illustrated in FIG. 2C, a bus command can be identified via a different transfer attribute value, (e.g., MI[2]). This bus command can include an address tenure command 230, which is identical to that produced by MI[1], however, it also produces a subsequent data tenure 232 on the transmit channel containing an “initialization value” D1 to be used during the memory initialization process from the start address A1 to end address B1. Once the memory controller is routed the data initialization command it can perform the requested initialization operation.

In yet another embodiment as illustrated in FIG. 2D, another bus command can be identified via a different transfer attribute value, (e.g., MC[1]). This bus command can include multiple address tenure commands 240 and 242, which are similar to that produced by MI[1]. For example, this bus command can be used during the memory copy process where the memory values are copied from the start address A1 to end address B1 and written to start address A2 to end address B2. Once the memory controller is routed the second set of addresses it can performs the requested memory copy operation.

As illustrated above this special bus command of the two-channel bus structure provides a efficient way of implementing the memory initialization function. For example, efficiencies include but are not limited to: a single bus command/transaction to create the memory initialization; the interconnect designates which memory controller to steer the command to based on the “start” address; and selectable formats with and without an “initialization” value. Also, as noted above, the special bus command can define an efficient memory copy function. Further, the end addresses may be substituted with lengths (e.g., bytes of memory) to be initialized or copied.

Embodiments of the invention place the functionality of memory initialization in the memory controller, which saves both time and energy. Time is saved since the processor can continue on with processing instead of looping over addresses (e.g., compare N processes performed in FIG. 1A vs. 1 in FIG. 1B). Energy can be saved for the following reasons: the processor 102 executes less code; individual memory writes are not sent from the processor 102 to the memory controller 106; and the memory controller 106 can improve the writes to the memory 108 and reduce the number of value toggles on the memory data lines. For example, the memory controller 106 can initialize a page of memory at a time, holding the data lines constant during the entire page of writes.

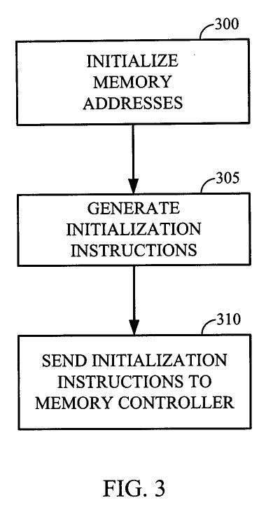

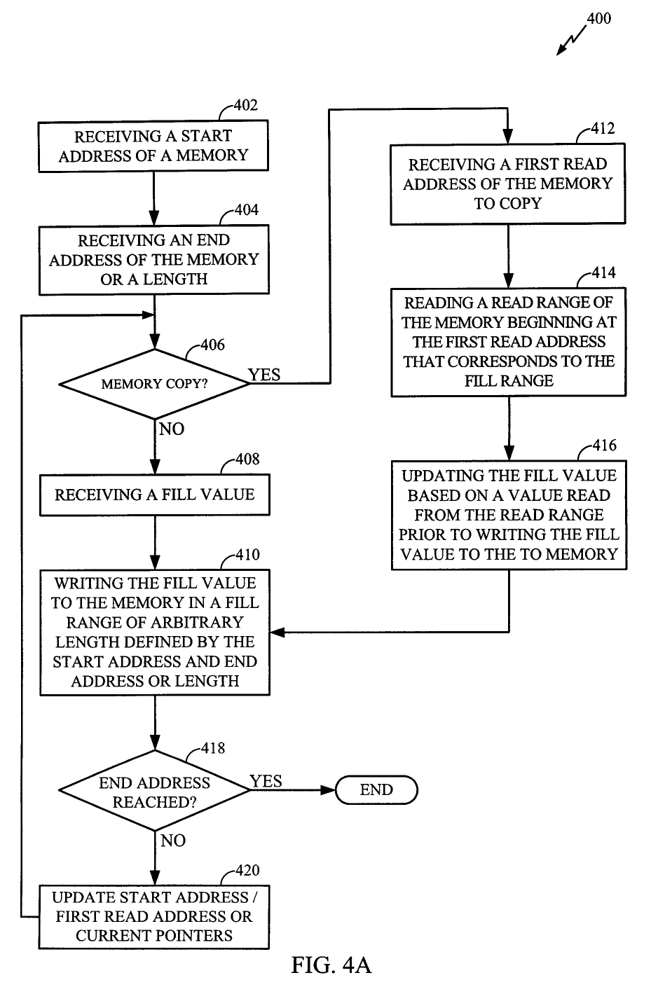

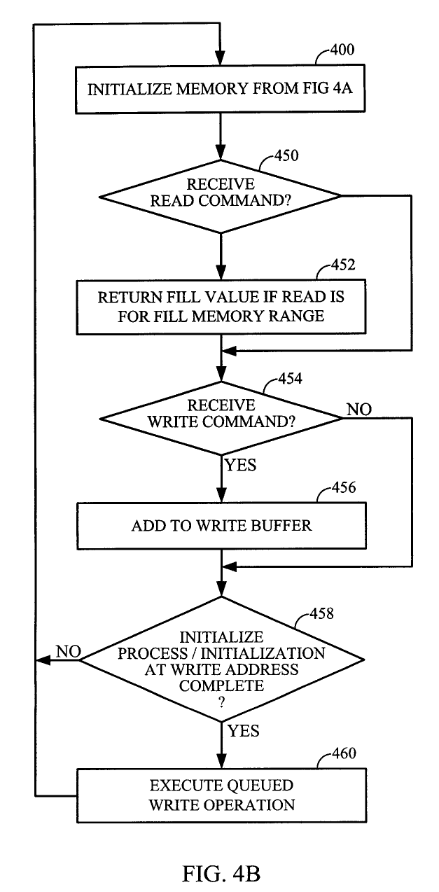

Generally, as will be described in greater detail below with respect to FIGS. 3 and 4A-B, the processor 102 may issue initialization instructions to the memory controller 106 which instruct the memory controller 106 to initialize a plurality of memory addresses (e.g., memory addresses positioned within a designated memory address range).

FIGS. 3, 4A and 4B collectively illustrate an example memory initialization process performed within the computing system 100 of FIG. 1B. In the description below, the process of FIG. 3 is performed at the processor 102 of FIG. 1B, and the processes of FIGS. 4A and 4B are performed at the memory controller 106 of FIG. 1B. However, it is understood that the example processes of FIGS. 3, 4A and 4B may alternatively be performed within any type of computing or memory system.

In the embodiment of FIG. 3, in 300, the processor 102 determines whether to initialize data at one or more memory addresses of the memory 108. For example, the determination of block 300 may be based on memory requirements associated with a software program being executed by the processor 102 or scheduled to be executed by the processor 102 of FIG. 1B. Thus, in an example, if the software program or application routing will use up to 10,000 bytes of data, the processor 102 may determine to initialize data at a number of memory addresses of the memory 108 corresponding to 10,000 bytes of data.

In 305, the processor 102 generates initialization instructions based on the number of memory addresses determined for initialization from 300. The initialization instructions can include a range of memory addresses to be initialized (e.g., a start and end address as discussed in relation to FIG. 2B) and optionally an initialization value (see, e.g., FIG. 2C). In another alternative, the initialization value need not be included within the initialization instructions, but rather may be implicit or assumed by the memory controller 106. For example, the initialization value may be assumed to be set to “0” or some other constant unless the initialization value is included within the initialization instructions is set to a level other than “0”. In another example, the initialization value may correspond to information. For example, if a substantially blue color frame is being decoded for a streaming video application, the memory addresses associated with a next frame to be displayed may be initialized to a value representative of a solid “blue” frame, such that only the eventual non-blue portions of the next frame need be updated during video decoding.

In an example, assume that 10,000 memory addresses are determined to be initialized in 300, and that the initialization value is “0”. With these assumptions, in an example, the initialization instructions may be represented with programming logic as follows:

Initialization Instructions {
Initialize from Address [0000] to Address [9999] with data (“0”);
}

### INITIALIZATION INSTRUCTION EXAMPLE 1

As shown in the example programming logic above, the initialization instructions may be relatively simple as well as relatively short. As will be appreciated, the above example programming logic instructs the memory controller 106 to initialize memory addresses [0000] through [9999] with logic “0”, per the assumptions above. However, it is understood that other examples of programming logic need not initialize the particular addresses given above in order to initialize 10,000 memory addresses, but rather may designate any memory address range available within the memory 108. In an example, only two addresses (e.g., [0000] and [9999]) need be sent from the processor 102 to the memory controller 106 in support of the initialization operation. In another example, a single address (e.g., [0000]) and an offset value or length (e.g., 10000) may be sent in place of two separate memory addresses from the processor 102 to the memory controller 106 in support of the initialization operation.

In yet another example, the initialization instructions may instruct the memory controller 106 to initialize a first set of memory addresses with data copied from other memory addresses (see, e.g., FIG. 2D). Thus, the given initialization value in this case is not one constant value, but rather may correspond to the values of data at the corresponding memory addresses to be copied. In this example, the initialization instructions may be represented with programming logic as follows:

```
Initialization Instructions {
      Initialize from Address [0000] to Address [9999] with data at
Address [10000] to [19999];
    }
```

### INITIALIZATION INSTRUCTION EXAMPLE 2

As shown in the example 2 programming logic above, the memory controller 106 is instructed to initialize memory addresses [0000] through [9999] with data at memory addresses [10000] to [19999]. Again, each of the two respective memory address ranges in this example may either be represented as a set of two memory addresses, or alternatively a single memory address and an offset value or length. The initialization instruction example 2 is slightly more complex from the standpoint of the memory controller 106, as the memory controller 106 reads the data at the memory addresses to be copied as well as writes the read data to the corresponding target memory address.

Returning to the embodiment of FIG. 3, in 310, the processor 102 sends the initialization instructions to the memory controller 106 (e.g., via bus 104 such as a multi point bus connection, a single point bus connection, a dedicated connection, etc.). In one embodiment, the memory initialization command (e.g., MI[1]) may be sent via an alternative bus such as a configuration bus (e.g., not the bus used for memory write/read instructions) that connects the memory controller 106 with processor 102.

FIG. 4A is a flowchart illustrating a method 400 in accordance with an embodiment of the invention. The method can begin in block 402 by receiving a start address of a memory. An end address of the memory or length is received in block 404 If the instruction is not a memory copy, decision block 406, then a fill or initialization value is received in block 408. In block 410, the fill value is written to the memory in a fill range of arbitrary length defined by the start address and end address or length (see, e.g., FIG. 2C). Accordingly, the fill value (or default initialization value) can be used to initialize the memory with little consumption of bandwidth on the write bus 104 coupling the processor 102 to the memory controller 106, as the process is performed locally at the memory controller 106.

Optionally, a memory copy can be detected using the method 400 illustrated, if the received command is for a memory copy. In decision block 406, a memory copy instruction is detected. If the instruction is for a memory copy, the method can further include receiving a first read address of the memory to copy, in block 412. A read range of the memory is read beginning at the first read address that corresponds to the fill range, in block 414. For example, the read range may be established by the first read address and an ending read address (see, e.g., FIG. 2D), the first read address and a length, and the like. In block 416, the fill (or initialization) value can be updated based on a value read from the read range prior to writing the fill value to the memory.

As illustrated, if the end address is reached in block 418, the method ends. If not, in block 420, the start and first address can be updated to the next address to be read and written, respectively. Alternatively, a pointer to the current read and write addresses can be updated and the original start and first read addresses can be maintained. The process can then continue until the memory is copied or initialized over the designated range.

FIG. 4B is a flowchart illustrating another embodiment of a memory initialization process performed at the memory controller 106 according to an embodiment of the invention. In the embodiment of FIG. 4B, in block 400, the memory controller 106 executes the initialization instructions (e.g., initialization instruction example 1, initialization instruction example 2, etc. as illustrated in FIG. 4A). In block 450, while the initialization process of block 400 is being performed, the memory controller 106 can determine if any subsequent read commands have been received from the processor 102. If the memory controller 106 determines that one or more read commands have been received from the processor 102, the process advances to block 452; otherwise, the process advances to block 454. In block 452, the memory controller 106 responds to the one or more received read commands with the fill/initialization value as read response data for each memory address designated by the read command that is in the fill/initialization memory range. In an example, the memory controller 106 need not read the initialization value from the designated memory address, but rather may simply automatically respond with the fill/initialization value. Accordingly, the read operation need not actually be performed in order to provide the read response data, thereby increasing an efficiency of the computing system 100.

In an alternative example, while not expressly shown in FIG. 4B, the initialization process of block 400 may be interrupted in response to the receipt of one or more read commands if the read command requests a data read operation upon a memory address that has not yet been initialized (e.g., based on a pointer indicating a current memory address position of the initialization process). In other words, the data read operation in this example is actually performed as in the conventional art, and the initialization process of 400 resumes after the read operation completes.

In another alternative example, if the initialization of block 400 is executed with programming logic similar to the initialization instruction example 2 (e.g., a memory copy type operation which copies memory at a given memory device from one portion to another portion), block 452 may not return the initialization value, but rather may advance directly to block 454. For example, in a memory copy-type operation, the initialization value is not necessarily known at the memory controller 106, but instead may require a read operation of one or more memory addresses in order to ascertain. Accordingly, based on system design preferences, the initialization of block 400 need not be interrupted in order to respond with the read data in this scenario. For example, a read command for a memory address in the target or destination portion of a memory copy operation may either be ignored until it can be serviced, or alternatively may be added to a read command queue which is performed after the initialization 400 completes or after the memory address associated with the read command has been initialized or copied (e.g., based on a pointer indicating a current memory address position of the initialization process).

In block 454, while the initialization process of block 400 is being performed, the memory controller determines whether any subsequent write commands have been received from the processor 102. If the memory controller 106 determines that one or more write commands have been received from the processor 102, the process advances to block 456; otherwise, the process advances to block 458. In block 456, the memory controller 106 adds the one or more write commands to a write buffer/queue. In an example, the write queue may be stored locally at the memory controller 106. In another example, the write command queue may be configured to store up to a threshold number of write commands. In this example, any write commands received in addition to the threshold number (e.g., write commands received after the write queue is full) may be ignored until they can be serviced (i.e., not stored at the memory controller 106) and/or may not be acknowledged (which would allow the memory controller to apply back pressure to the bus/processor).

In block 458, the memory controller 106 determines whether the initialization operation of block 400 is complete (e.g., whether all or a portion containing the designated memory addresses from the initialization instructions has been initialized). If the memory controller determines that the initialization operation of block 400 is complete, the process of FIG. 4B advances to block 460; otherwise, the process returns to block 400 and continues the initialization operation.

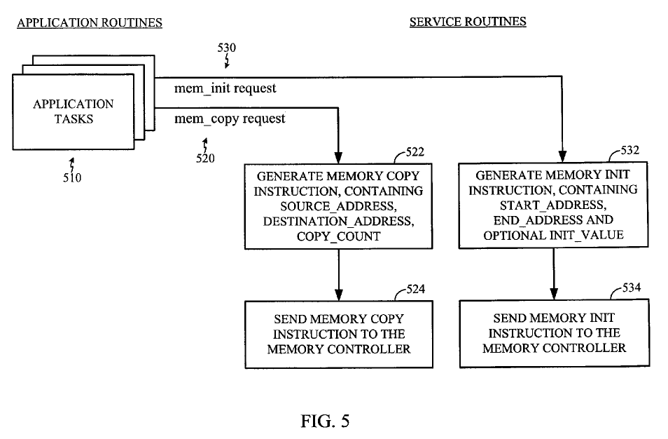

Another embodiment of the invention is illustrated in FIG. 5 having separate application routines 510 for the memory copy and memory initialization. In this configuration, an application routine 510 running on processor 102 can invoke specific services for a memory copy (mem_copy request) 520 and a memory initialization (mem_init request) 530. Upon requesting the mem_copy 520, an instruction containing a source and a destination address, and a copy count, in block 522, is generated and then in block 524, the mem_copy instruction is sent to the memory controller 106. Upon requesting the mem_init 530, an instruction containing a start and an end address, and optionally an initialization value, in block 532 is generated and then in block 534, the mem_copy instruction is sent to the memory controller 106.

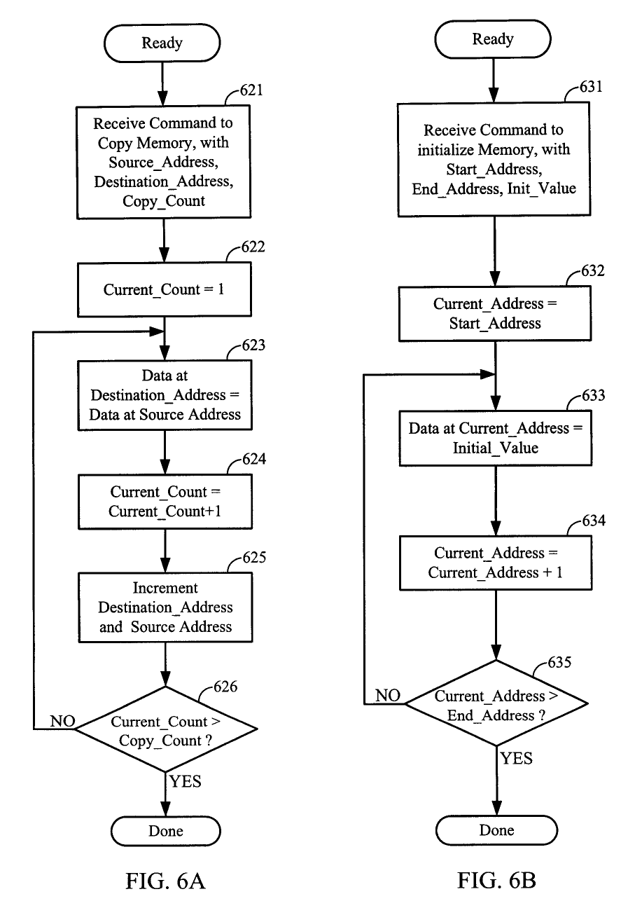

FIG. 6A illustrates a flowchart for performing a memory copy at the memory controller after receipt of the memory copy instruction (e.g. 520 in FIG. 5). For example, the mem_copy instruction and information may be communicated to memory controller using the techniques described in relation to FIG. 2D, except a copy count will be provided in a data tenure instead of the second set of addresses. In block 621, the copy command containing a source and a destination address, and a copy count is received. In block 622, a counter is set to one, that determines the copy count. In block 623, data from the source address is copied to the destination address. In block 624, the copy counter is incremented. In block 625, the source address and destination address are incremented to the next address to be copied from and written to respectively. In decision block 626, the copy counter is compared to the copy count value received. If the current counter is less than or equal to the copy count, the process loops to block 623 and continues until the copy process is complete.

FIG. 6B illustrates a flowchart for performing a memory initialization at the memory controller after receipt of the memory initialization instruction (e.g. 530 in FIG. 5). For example, the mem_init instruction and information may be communicated to memory controller 106 using the techniques described in relation to FIG. 2C. In block 631, the initialization command containing a start and an end address, and optionally an initialization value is received. In block 632, a current address is set to the start address. In block 633, the value stored at the current address is set to the initialization value or optionally to a default value. In block 634, the current address is incremented. In decision block 635, the current address is compared to the end address. If the current address is not greater than the end address, the process loops to block 633 and continues until the initialization is complete.

It will be appreciated that the embodiments of the invention are not limited to the examples provided in the foregoing. For example, the mem_copy instruction may include a source start and end address and a destination start and end address, instead of a copy count as describe above. Likewise, the mem_init instruction may contain a start address and length, instead of a start and end address. However, regardless of the specific format for communicating the instructions, each embodiment substantially reduces the bus bandwidth and processor power used by reducing the number of processor initiated transactions that are communicated to the memory controller for a given function (e.g., mem_init or mem_copy).

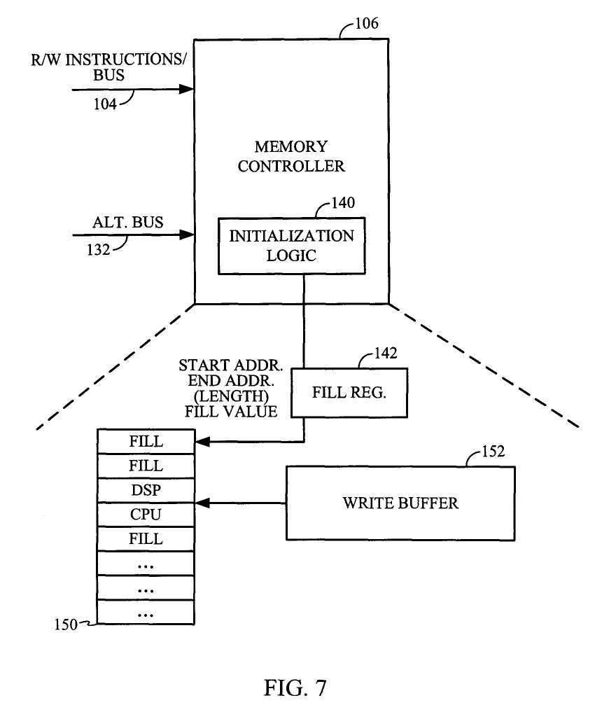

FIG. 7 is a more detailed illustration of memory controller 106 according to embodiments of the invention. The memory controller 106 can include initialization logic 140, a fill register 142, and conventional elements such as a transfer queue 150 and a write buffer 152. The initialization can be configured to receive an initialization instruction from a master (e.g., CPU, DSP, etc.) and to fill a range of memory as specified in the initialization instruction (see, e.g., Instruction Example 1 and FIGS. 2B-C, above).

For example, in one embodiment, the initialization logic 140 can include logic configured to receive a start address of a memory, logic configured to receive an end address of the memory or a length, logic configured to receive a fill value, and logic configured to write the fill value to the memory in a fill range of arbitrary length defined by the start address and end address or length. The initialization logic 140 can be configured to use a transfer queue 150 of memory controller 106 that is also shared with other masters (e.g., DSP, CPU, etc.). The fill data can be placed on the transfer queue 150 by initialization logic 140 using established protocols for the memory controller 106. Accordingly, the initialization logic 140 can be more easily integrated into existing memory controller designs and work cooperatively with other masters in the system.

For example, as illustrated in FIG. 7, the transfer queue 150 may have sequential fill operations written from the initialization logic 140. Accordingly, an aspect of the invention can include logic configured to format write commands to write the fill value to the fill range, to comply with the transfer queue. For example, each fill can be compliant with standard size and code for a particular operation. For example, the top “Fill” may be a 32 byte write command starting at the start address (e.g., 00000) as specified in the initialization instruction. The next “Fill” may be a write command for the next block of addresses (e.g., a 32 byte write command starting at address 00032). As discussed herein, the write size in bytes and the two sequential write commands are merely examples, and embodiments of the invention are not limited to these specific values or sequence. The next two entries in the transfer queue 150 are from other masters (e.g., a DSP and CPU), which are interleaved with the fill instruction. As can be appreciated, multiple processors/masters may access the memory controller 106 and the initialization logic 140 can be configured to operate cooperatively with other masters. Alternatively, the initialization logic 140 could be configured to block the other masters and perform the initialization sequentially until the entire memory range is initialized with the fill value.

Additionally, since the fill data/value will be the same, a fill register 142 can be included in the memory controller 106 to queue the fill values prior to placing them in transfer queue 150 for writing to the memory 108. One advantage of having a separate fill register 142 is it prevents writing redundant data to the write buffer 152, which would limit the spaces in the write buffer 152 available for the other masters (e.g., DSP, CPU).

As discussed above, the memory controller 106 is configured to process a read/write instructions from one or more master devices that communicate with the memory controller over a bus 104 (e.g., AXI bus, two-channel bus, etc.). However, at least one of the start address, end address or length, or fill value can be communicated to the memory controller over an alternative bus 132 (e.g., a configuration bus). Also, as discussed in relation to FIGS. 2A-D, a transfer attribute value can be communicated over the alternate bus and the related address and data can be communicated over the transmit bus. Using an alternative bus 132 can prevent blocking a portion of the memory 108 for use by the initialization command in architectures where the addressing of the memory controller corresponds to the physical memory and also can reduce the traffic on the standard bus 104.

In another aspect of the invention, the initialization logic can include logic configured to detect a read request for a memory address within the fill range and logic configured to return the fill value prior to actually writing the fill value to the memory address specified in the read request. Accordingly, reads can be serviced even before the fill value is written to the memory which will improve the responsiveness of the system. Likewise, another aspect of the invention can include logic configured to update the start address to reflect the last address value written to make memory addresses initialized with the fill value available for access. Accordingly, by updating the start address to the next address to be written any memory address already initialized can be available for use by the rest of the system.

In another embodiment of the invention, the initialization logic 140 or memory controller 106 can further include logic configured to receive a first read address of the memory to copy, logic configured to read a read range of the memory beginning at the first read address, wherein a length of the read range corresponds to a length of the fill range; and logic configured to update the fill value based on a value read from each address of the read range prior to writing a corresponding address of the fill range with the fill value. Accordingly, the memory controller 106 can perform a local copy (see, e.g., Instruction Example 2) using the initialization logic 140. In this case, instead of a fixed value for the fill value, the fill value can be updated from the data read from the memory locations defined in the copy command and the updated values can be used to initialize the memory space. Accordingly, the initialization logic 140 can place a read request for the first read memory address on the transaction queue 150, capture the read data from memory (e.g., 108) and then place a write command on the transfer queue 150 to write the read value to the start address. The read and write addresses can be updated as the process continues until the end address is reached for both the read range and the fill range. The values read from the read range can be stored in the write buffer 152 or another buffer associated with initialization logic 140 until they are placed on the transfer queue for writing back to the memory. Accordingly, this aspect of the invention can also reduce the traffic on the bus (e.g., 104 or 204/208) and improve memory copy performance as the process is performed locally at the memory controller 106.

As described above the initialization logic may perform both the memory initialization and memory copy instructions, based on the type of instruction received. However, embodiments of the invention can also include individualized logic for each operation, which may be realized as separate state machines for each function. Likewise, embodiments of the invention are not limited to the illustrated configuration of buffers, registers, etc., as these may be shared or separated as desired by the system designer.

It will be appreciated that information and signals may be represented using any of a variety of different technologies and techniques. For example, data, instructions, commands, information, signals, bits, and symbols that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the embodiments of the invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., access terminal). In the alternative, the processor and the storage medium may reside as discrete components in a user terminal.

Embodiments of the invention being thus described, it will be appreciated that the same may be varied in many ways. For example, while the computing system 100 of FIG. 1B is illustrated as a single-processor system, embodiments of the invention may alternatively be implemented within a multi-processor system configuration.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A memory controller comprising:
logic configured to receive a start address of a memory;
logic configured to receive an end address of the memory or a length;
logic configured to receive a fill value; and
logic configured to write the fill value to the memory in a fill range of arbitrary length defined by the start address and end address or length.

2. The memory controller of claim 1, further comprising:
logic configured to receive a first read address of the memory to copy;
logic configured to read a read range of the memory beginning at the first read address, wherein a length of the read range corresponds to a length of the fill range; and
logic configured to update the fill value based on a value read from each address of the read range prior to writing a corresponding address of the fill range with the fill value.

3. The memory controller of claim 1, wherein the memory controller is configured to process read/write instructions from one or more master devices that communicate with the memory controller over a standard bus.

4. The memory controller of claim 3, wherein at least one of the start address, end address or length, or fill value is communicated to the memory controller over an alternative bus.

5. The memory controller of claim 4, wherein the alternative bus is a configuration bus.

6. The memory controller of claim 1, further comprising:
a transfer queue;
a fill register; and
a write buffer.

7. The memory controller of claim 6, wherein write commands to write the fill value to the memory in the fill range are written to the memory via the fill register and the transfer queue.

8. The memory controller of claim 7, wherein the write buffer is configured to receive write instructions from one or more masters coupled to the memory controller.

9. The memory controller of claim 6, further comprising:
logic configured to format write commands to write the fill value to the fill range, to comply with the transfer queue.

10. The memory controller of claim 1, further comprising:
logic configured to detect a read request for a memory address within the fill range; and
logic configured to return the fill value prior to actually writing the fill value to the memory address specified in the read request.

11. The memory controller of claim 1 further comprising:
logic configured to update the start address to reflect the last address value written to make memory addresses initialized with the fill value available for access.

12. A method for initializing or copying data in a memory, performed at a memory controller, the method comprising:
receiving a start address of a memory;
receiving an end address of the memory or a length;
receiving a fill value; and
writing the fill value to the memory in a fill range of arbitrary length defined by the start address and end address or length.

13. The method of claim 12, further comprising:
receiving a first read address of the memory to copy;
reading a read range of the memory beginning at the first read address, wherein a length of the read range corresponds to a length of the fill range; and
updating the fill value based on a value read from each address of the read range prior to writing the fill value to a corresponding address of the fill range.

14. The method of claim 12, further comprising:
processing at the memory controller read/write instructions from one or more master devices that communicate with the memory controller over a standard bus.

15. The method of claim 12, further comprising:
formatting write commands to write the fill value to the fill range, to comply with a transfer queue of the memory controller.

16. The method of claim 12, further comprising:
detecting a read request for a memory address within the fill range; and
returning the fill value prior to actually writing the fill value to the memory address specified in the read request.

17. The method of claim 12, further comprising:
updating the start address to reflect the last address value written to make memory addresses initialized with the fill value available for access.

18. The method of claim 12, wherein initialization instructions are received from a processor coupled to the memory controller.

19. A computer system, comprising:
a processor configured to send one of a memory initialization instruction or a memory copy instruction including an arbitrary range of memory addresses to initialize or copy; and
a memory controller coupled to the processor, wherein the memory controller is configured to receive the memory initialization instruction or memory copy instruction from the processor, and is configured to initialize or copy the range of memory addresses in accordance with the received instruction.

20. The computer system of claim 19, further comprising:
a two-channel bus comprising a transmit channel and read data channel, wherein the memory controller is coupled to the processor via the two-channel bus.

21. The computer system of claim 20, further comprising:
an alternate bus coupling the processor and the memory controller, wherein a transfer request attribute is transmitted on the alternate bus to inform the memory controller of a corresponding memory initialization or copy instruction.

22. The computer system of claim 21, wherein the transfer request attribute includes at least one of:
a first memory initialization attribute associated with a memory start address and a memory end address;
a second memory initialization attribute associated with a memory start address, a memory end address and an initialization value;
a third memory initialization request associated with a memory start address and a length;
a fourth memory initialization attribute associated with a memory start address, a memory length and an initialization value;
a first memory copy attribute associated with a source start address, a source end address, a destination start address and a destination end address; or
a second memory copy attribute associated with a source address, a destination address and a copy length.

23. The computer system of claim 20, wherein two memory addresses are transmitted in a first broadcast cycle on the transmit channel.

24. A method for memory initialization performed at a memory controller comprising;
receiving a memory initialization command including a start address, an end address and an initialization value;
setting a current address to the start address;
writing the initialization value to the memory at the current address;
incrementing the current address; and
repeating the writing and incrementing, if the current address is not greater than the end address.

25. A method for copying memory performed at a memory controller comprising;
receiving a memory copy command including a source address, a destination address and a copy count;
copying data from the source address to the destination address;
incrementing the source address and the destination address;
incrementing a current count; and
repeating the copying and incrementing, if the current count is not greater than the copy count.
